(19) United States
(12) Patent Application Publication
(10) Pub. No.: US 2013/0237682 A1
(43) Pub. Date: Sep. 12, 2013

(54) METHOD FOR PREPARING STAR POLYMERS

(71) Applicants: Didier Bourissou, Plaisance du Touch (FR); Blanca Martin-Vaca, Toulouse (FR); Aurélie Alba, Toulouse (FR); Roland Cherif-Cheikh, Castelldefels (Barcelona) (FR); Anne-Paula De Sousa Delgado, Molins de Rei (Barcelona) (FR)

(72) Inventors: Didier Bourissou, Plaisance du Touch (FR); Blanca Martin-Vaca, Toulouse (FR); Aurélie Alba, Toulouse (FR); Roland Cherif-Cheikh, Castelldefels (Barcelona) (FR); Anne-Paula De Sousa Delgado, Molins de Rei (Barcelona) (FR)

(21) Appl. No.: 13/885,663

(22) PCT Filed: Nov. 14, 2011
(86) PCT No.: PCT/FR2011/000601

§ 371 Date: May 15, 2013

(30) Foreign Application Priority Data
Nov. 15, 2010 (FR) 10/04427

(51) Int. Cl. C08G 63/82

(52) U.S. Cl. CPC C08G 63/823
USPC 528/274; 528/271

(57) ABSTRACT

The invention relates to a method for preparing linear polymers having an amide end or having a star architecture comprising an amide core, by means of a ring opening using lactide and glycolide monomers or a lactide monomer ring in the presence of a catalyst, wherein the method includes the steps of: (i) reacting the excess monomer(s) with an initiator in a solvent, said initiator being selected from among an amine and an amino alcohol, given that the initiator has at least one primary or secondary amine function; (ii) adding a catalyst, said catalyst being a non-nucleophilic base and including at least one neutral sp2 nitrogen atom; and (iii) neutralizing the reaction mixture. Said novel method is particularly advantageous in that it can be easily monitored and enables better modulation of the polymers, and thus of the properties thereof, than the methods of the prior art. The invention also relates to novel polymers that are obtainable by means of said method.

### FIELD OF THE INVENTION

A subject of the present application is a method for preparing star polymers, based on lactide and/or glycolide. This method can be easily controlled and is more efficient than the methods of the prior art. It is particularly useful in that the polymers obtained are functionalized on all the branches of the star, even in the case of oligomers.

### STATE OF THE ART

Nowadays, attention is increasingly being paid to synthetic polymers for preparing artificial organs and formulating medicaments [Chem. Eng. News 2001, 79 (6), 30]. The polymers concerned must satisfy a certain number of criteria and, in particular, they must be biocompatible. Biodegradability is an additional advantage if the polymer must be eliminated after an appropriate period of implantation in an organism. In this regard, copolymers based on lactic and glycolic acid (PLGA) are of very great benefit as they are sensitive to hydrolysis and are degraded in vivo with the release of non-toxic by-products. The field of application of the PLGAs is very broad (Adv. Mater. 1996, 8, 305 and Chemosphere 2001, 43, 49). In the field of surgery, they are used for the synthesis of multi-strand wires, sutures, implants, prostheses etc. In pharmacology, they allow the encapsulation, transfer and controlled release of active ingredients. For all these applications, one of the key factors is the degradation rate of the PLGAs which certainly depends on their structure (chain length, dispersity, proportion, stereochemistry and chain formation of the monomers etc.).

Branched polymers, which include star polymers, dendrimers and hyperbranched polymers, have been the subject of numerous studies, due to their useful rheological and mechanical properties.

In particular, star polymers, or polymers with star architecture, can be used in the administration of active ingredients and have useful release profiles. This type of polymer is generally prepared from polyol initiators comprising n alcohol functions in order to produce stars with n arms.

Moreover, the star polymers have glass transition temperatures, as well as a viscosity in the vitreous state, different from their linear equivalents. The same applies as regards their crystallinity—and therefore their melting temperature—which is also different from their linear equivalents. In particular, it is described that polymers of high molecular mass have a lower glass transition temperature and a lower melting temperature than their linear equivalents. However, the crystalline phase retains the same nature in both architectures.

A biodegradable star polymer (for example, PLGA) will have a much more rapid initial degradation rate than its linear equivalent with the same mass. In fact, it has been shown that by chemical or enzymatic hydrolysis, the first cleavages of ester bonds take place in the core of the star, close to the initiator, thus releasing linear polymers with lower molecular masses. Thus, the rate of release and degradation is to be correlated with the structure of the polymer matrix.

These differences in properties therefore give access to useful innovative matrices. For example, the encapsulation of active ingredients in star polymers in the case of PLGAs has been described by A. Breitenbach, Y. X. Li, T. Kissel, Journal of Controlled Release 2000, 64, 167.

Ring-opening polymerization starting from metallic complexes for the synthesis of polymers with star architecture has been described since the 1990s. They are mainly prepared by solution or bulk polymerization, with metallic catalysts such as tin octanoate, even if other systems based on Fe, Zn, Al etc. have been reported (H. R. Kricheldorf, Polymer for Advanced Technologies 2002, 13, 969; A. Finne, A.-C. Albertsson, Biomacromolecules 2002, 3, 684; H. R. Kricheldorf, H. Hachmann-Thiessen, G. Schwarz, Biomacromolecules 2004, 5, 492; I. Arvanitoyannis, A. Nakayama, E. Psomiadou, N. Kawasaki, N. Yamamoto, Polymer 1996, 37, 651).

There are very few examples in the literature of synthesis of star polymers based on lactic acid (PLA) with non-metallic catalysts. In 2007, K. Numata, R. K. Srivastava, A. Finne-Wistrand, A.-C. Albertsson, Y. Doi, H. Abe, Biomacromolecules 2007, 8, 3115 described for the first time the bulk enzymatic polymerization of lactide in the presence of polyols. From the PLA, stars with 2 to 22 branches are obtained, with degrees of polymolecularity comprised between 1.0 and 1.5, in the presence of lipase PS, at 140° C., after 5 to 7 days of polymerization.

The examples of preparation of polyesters with star architecture using organic catalysts involve monomers other than lactide, such as □-valerolactone or ε-caprolactone (F. Sanda, H. Sanada, Y. Shibasaki, T. Endo, Macromolecules 2002, 35, 680; P. V. Persson, J. Casas, T. Iversen, A. Cordova, Macromolecules 2006, 39, 2819 and F. Zeng, H. Lee, M. Chidiac, C. Allen, Biomacromolecules 2005, 6, 2140). With the catalysts used (fumaric or lactic acids) the required reaction temperatures are relatively high (of the order of 90° C.).

The examples described with organocatalyzed ring opening of the lactide are all based on macroinitiators. At present there is no effective catalytic system for the synthesis of oligomers with low molar masses from a polyol, ensuring total functionalization of the arms.

The applicant has developed a novel non-metallic, easily controllable method, which is more effective than the methods of the prior art in the case of oligomers.

### SUMMARY OF THE INVENTION

A subject of the invention is therefore a method for preparing star polymers based on a lactide monomer and a glycolide monomer or a lactide monomer, by ring opening in the presence of a catalyst, in which:
the catalyst has the formula

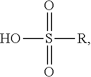

in which R is a C₁ to C₆ haloalkyl;
the initiator is a polyol comprising from 3 to 6 hydroxyl functions.

Preferably, the monomer is lactide.

Preferably, the polymers are prepared based on a lactide monomer and a glycolide monomer.

Preferably, the reaction takes place in an organic solvent, even more preferably in a halogenated or aromatic solvent.

Preferably, the solvent is a halogenated solvent, preferably, the solvent is dichloromethane.

Preferably, the initiator is a polyol comprising from 3 to 4 hydroxyl functions.

Preferably, the initiator is glycerol.

Preferably, the catalyst is trifluoromethanesulphonic acid.

Preferably, the reaction temperature is from 0 to 150° C., more preferably from 20 to 45° C.

Preferably, the initial monomer concentration/OH function concentration ratio of the initiator is from 200/1 to 1/1.

Preferably, the initial monomer concentration/OH function concentration ratio of the initiator is from 100/1 to 2/1.

Preferably, the initial monomer concentration/OH function concentration ratio of the initiator is from 20/1 to 4/1.

Preferably, the initial catalyst concentration/OH function concentration ratio of the initiator is from 0.1 to 20.

Preferably, the initial catalyst concentration/OH function concentration ratio of the initiator is from 0.2 to 10.

Preferably, the initial catalyst concentration/OH function concentration ratio of the initiator is from 0.3 to 6.

### DETAILED DESCRIPTION OF EMBODIMENTS OF THE INVENTION

A subject of the invention is therefore a method for preparing star polymers based on lactide and/or glycolide. By star polymer is meant a polymer having a single branch point from where several linear chains emanate.

The polymerization reaction is of ring-opening type. Ring-opening polymerization is an addition polymerization. It can be diagrammatically represented as follows:

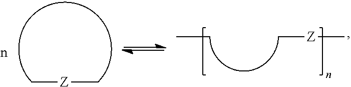

with n being the number of monomers.

The reaction is carried out starting from a lactide monomer and a glycolide monomer, or from a lactide monomer alone. According to a variant, the monomer is lactide. According to another variant, the reaction is a co-polymerization and the reaction is carried out from lactide and glycolide.

The reaction is carried out in the presence of a catalyst, of formula

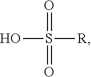

in which R represents a haloalkyl. By haloalkyl is meant an alkyl radical substituted by one or more halogen atoms. The alkyl radical comprises from 1 to 6 carbon atoms, preferably from 1 to 4 carbon atoms. The halogen atom is chosen from F, Cl, Br and I. For example, the haloalkyl is C₂ F₆ or CF₃. Preferably, the haloalkyl is CF₃.

The initiator of the reaction is a polyol comprising from 3 to 6 hydroxyl functions, i.e. the initiator is an organic molecule comprising from 3 to 6 —OH functions. The polyol as defined in the present invention can be an aliphatic or cyclic carbon-containing chain. The polyol can also contain other organic functions, such as for example one or more aldehyde and/or ketone functions. For example, the polyol can be chosen from glycerol, trimethylolethane, trimethylolpropane, pentaerythritol, dipentaerythritol, inositol, xylitol, mannitol, sorbitol, erythrose, threose, arabinose, ribose, gulose, idose, altrose, alose, talose, sorbose, mannose, glucose, fructose, galactose, sucrose, lactose. Preferably, the initiator is pentaerythritol, dipentaerythritol, glycerol, trimethylolethane, trimethylolpropane, or sorbitol. More preferably, the initiator is glycerol.

The reaction takes place in a solvent. The term “solvent” here means a single solvent or a mixture of solvents. Preferably, the solvent is chosen so that the polymer formed is soluble therein. Preferably, the solvent is chosen from the halogenated solvents and the aromatic solvents. For example, the solvent is chosen from dichloromethane, dichloroethane and toluene. Preferably, the solvent is dichloromethane.

Preferably, the reaction is carried out at a temperature comprised between the ambient temperature, i.e. approximately 25° C., and the boiling temperature of the chosen solvent. The reaction temperature is chosen so as to be below the degradation temperature of the polymer formed. For example, the temperature is from 0 to 150° C. Preferably, the temperature is from 10 to 90° C. Preferably also, the temperature is from 20 to 45° C., preferably from 20 to 30° C. For example, the reaction is carried out at ambient temperature.

Preferably, the reaction is stopped once the desired degree of polymerization is obtained. For example, the reaction is stopped when the consumption of the initial monomer is from 90 to 100%. Preferably, the reaction is stopped when the consumption of the initial monomer is greater than 94%. For example, the reaction is stopped by quenching. Alternatively, the reaction is stopped by the addition of a base. For example, the polymerization reaction is stopped by the addition of a basic resin, such as for example Amberlyst™ A21.

Preferably, the initial monomer concentration to OH function concentration ratio of the initiator is from 200/1 to 1/1, more preferably from 100/1 to 3/1, even more preferably from 20/1 to 4/1. For example, the ratio is from 8/1 to 6/1.

Preferably, the initial catalyst concentration to OH function concentration ratio of the initiator is from 0.1 to 20, more preferably from 0.2 to 10, even more preferably from 0.2 to 6.

The method according to the invention has numerous advantages. In particular, the method can be easily controlled. It is more efficient than the methods of the prior art. In particular, the polymers obtained are functionalized on all the branches of the star. This is also true during the synthesis of oligomers. By oligomer is meant a small polymer, preferably having a molar mass of less than 2000 g/mol.

Unless defined otherwise, all the technical and scientific terms used here have the same meaning as that commonly understood by an ordinary specialist in the field to which this invention belongs.

The following examples are given to illustrate the invention and should in no case be considered as limiting the scope of the invention.

### EXAMPLES

In the examples which follow and unless otherwise indicated, the following polymerization conditions are used: trimethylolpropane (TMP) is used after azeotropic distillation in toluene, pentaerythritol (PET) is dried under vacuum in the presence of P₂O₅, and glycerol is distilled. Unless otherwise indicated, the lactide is used in its racemic form (D,L) in dichloromethane [L]₀=1 mol/L), in the presence of 0.1 equivalent of trifluoromethanesulphonic acid per alcohol. Unless otherwise indicated, the polymerizations are carried out at ambient temperature (T=26° C.) under vigorous stirring. The polymers are obtained in reaction times close to those of their linear equivalents (approximately 5-7 hours).

On completion of the reaction, the catalyst is neutralized by the basic resin Amberlyst™ A21. The polymers are precipitated from a CH₂Cl₂/heptane mixture then dried under vacuum in a rotary evaporator for 48 hours.

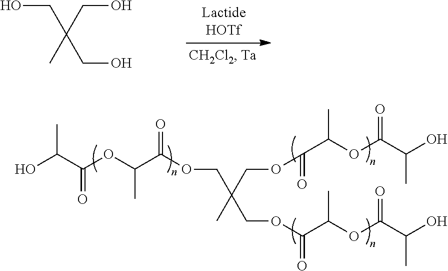

### Examples 1 to 4

| | | [OH]₀/ | | | DP_{NMR} | | | | |
|---|---|---|---|---|---|---|---|---|---|
| | | [L]₀/ | | | per | n(CH₂—OPLA)/ | Elemental | | |
| Ex | Polyol | [HOTf]₀ | M_{M} | I_{P} | arm | n(CH₂—OH)₀ | Analysis | CH₂Cl₂ | Heptane |
| 1 | TMP | 1/9/0.3 | 2054* | 1.15 | 2.8 | 3/3 | — | — | — |
| 2 | TMP | 1/6/0.3 | 1452 | 1.15 | 1.95 | 2.9/3 | F = 79 | 1.22% | 0.79% |
| | | | | | | | ppm S = | | |
| | | | | | | | 42 ppm | | |
| 3 | PET | 1/7.8/0.4 | 1689 | 1.26 | 1.8 | 3.7/4 | F = 39 | 1.87% | 0.87% |
| | | | | | | | ppm S = | | |
| | | | | | | | 28 ppm | | |
| 4 | Glycerol | 1/6/0.3 | 1516 | 1.12 | 1.95 | 2.9/3 | F = 58 | 0.03% | 0.13% |
| | | | | | | | ppm S = | | |
| | | | | | | | 21 ppm | | |

*91% conversion - T_{g} = 7° C.

In the case of a lactide/initiator ratio (initiator=trimethylolpropane) of 3/1, a hard, whitish polymer is obtained (T_{g}=7° C.).

In the case of a ratio of 2/1 (i.e. a lactide/[OH]₀ ratio of 6/1 for ttimethylolpropane), the polymer initiated with pentaerythritol is fairly hard, whereas that initiated with glycerol is the most fluid of the three (glass transition temperature Tg=3° C.).

Even with this monomer/initiator ratio, well-controlled polymers are obtained (DP_{NMR} (degree of polymerization measured by NMR) per arm close to the theoretical DP (degree of polymerization) of 2, degree of polymolecularity of approximately 1.2) with good initiation on all the alcohols: in the case of the triols, 2.9 CH₂ out of 3 have initiated. This measurement is determined by ¹H NMR spectroscopy on the integration of the CH₂—O-PLAs (and CH—O-PLAs in the case of glycerol) with respect to the signals observed at approximately 3.5 ppm (characteristic CH₂—OH and CH—OH region of the initiators). The mass spectrometry study by positive mode electrospray ionization confirms the exclusive initiation by the starting polyol in the case of trimethylolpropane and pentaerythritol.

### Examples 5 to 7 were Prepared According to the Following General Procedure

Lactide (LA) and prone initiator (polyol, 1 equivalent) are dissolved in freshly distilled dichloromethane ([L]₀=1 mol·L⁻¹). Trifluoromethanesulphonic acid (triflic acid) (0.05 equivalent per OH) is then added and the reaction medium is vigorously stirred at T=26° C. until the lactide is completely consumed, monitored by ¹H NMR spectroscopy.

4 equivalents (with respect to the triflic acid) of Amberlyst A21 resin (4.6 meq/g), previously dried over P₂O₅, are added. The reaction medium is stirred for 45 minutes then filtered. Twice 2 equivalents of Amberlyst A21 resin are added to the reaction medium which is stirred for 45 minutes then filtered. The reaction solvent is then evaporated off under vacuum and the polymer obtained is precipitated with a CH₂Cl₂/Heptane mixture (5/90). The supernatant is removed and the polymer is dried under vacuum at 60° C. for 48 hours.

### Example 5

### Polymer Initiated with Glycerol in the Presence of 4.5 Equivalents of D,L-Lactide

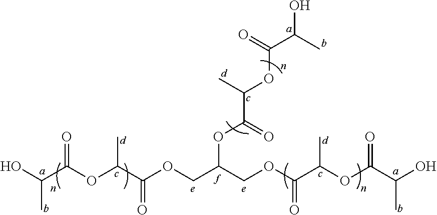

¹H NMR (δ, DMSO-d₆, 300.1 MHz): 5.48 (3H, m, OH), 5.30-5.05 (7.6H, m, CHₑ and CH_{f}), 4.41-4.05 (7H, m, CH_{2c} and CHₐ), 1.47 (19.7H, m, CH_{3d}), 1.30 (9.1H, m, CH_{3b}) ppm.

¹³C NMR (δ, DMSO-d₆, 75.5 MHz): 174.0 (CO), 169.6-169.1 (CO), 69.9-67.7 (CHpol), 65.7 (CHOH), 65.4 (CHOH), 62.6-62.3 (CH₂O), 59.1 (CH₂OH), 20.4-20.2 (CH₃OH), 16.6-16.4 (CH₃pol) ppm.

DP_{NMR}=4.5

% residual lactide (HPLC): 0.6%

SEC (THF): Mₙ=1055, M_{w}/Mₙ=1.09.

### Example 6

### Polymer Initiated with Trimethylolethane in the Presence of 6 Equivalents of D,L-Lactide

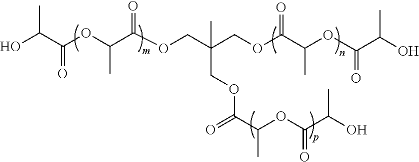

¹H NMR (δ, CDCl₃, 300.1 MHz): 5.25-5.11 (9H, m, CH), 5.05 (3H, br s, OH), 4.37 (3H, m, CH—OH), 4.11-4.05 (6H, m, CH₂), 1.59-1.47 (35.2H, m, CH₃), 1.02 (3H, m, CH₃) ppm.

% residual lactide (HPLC): 0.6%

DP_{NMR}=5.9

SEC (THF): Mₙ=1258, M_{w}/Mₙ=1.15

### Example 7

### Polymer Initiated with Pentaerythritol in the Presence of 8 Equivalents of D,L-Lactide

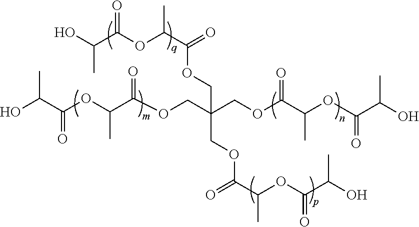

¹H NMR (δ, CDCl₃, 300.1 MHz): 5.23-5.09 (12H, m, CH), 4.35 (4H, m, CH—OH), 4.22-4.16 (8H, m, CH₂), 1.58-1.47 (50.4H, m, CH₃) ppm.

DP_{NMR}=8.4

SEC (THF): Mₙ=1576, M_{w}/Mₙ=1.26

### Examples 8 to 10

### Synthesis of PLA of Varying Masses

In the following Examples 8 to 10, trimethylolethane was chosen as initiator. For all the polymerizations, the trimethylolethane is used after sublimation. The lactide is used either in the racemic form (D,L), or in the enantiopure form (L).

The length of the polymer is dependent on the initial [Monomer M]ₙ/[Initiator I]₀ ratio. Different [M]₀/[I]₀ ratios are fixed for each polymerization with the aim of obtaining polymers of varying masses.

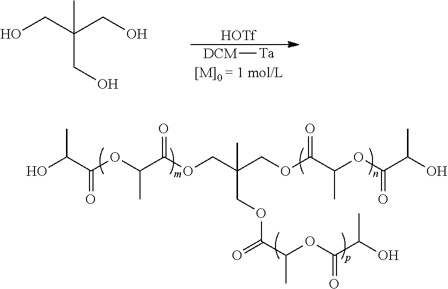

| | | | | | | | DPNmR | n(CH₂—OPLA)/ |
|---|---|---|---|---|---|---|---|---|
| Ex | [M]₀/[I]₀/[HOTf]₀ | Lactide | Time | Conversion | M_{w} | Iₚ | per arm | n(CH₂—OH)₀ |
| 8 | 30/1/3 | D, L | 1 h30 | 96% | 5292 | 1.25 | 7.5 | 3/3 |
| 9 | 50/1/3 | L | 3 h | 94% | 10108 | 1.10 | 14 | 3/3 |
| 10 | 100/1/3 | L | 7 h30 | 96% | 17934 | 1.17 | 30 | 3/3 |

The incorporation of the CH₂OH of the initiator is complete (monitored by ¹H NMR spectroscopy) in the case of each polymer.

Moreover, it is observed that the higher this ratio the greater the mass of the polymer obtained.

General Synthesis Protocol:

The lactide and the polyol (1 equivalent) are dissolved in freshly distilled dichloromethane ([LA]₀=1 mol·L⁻¹). Triflic acid (1 equivalent per OH) is then added and the reaction medium is vigorously stirred at T=26° C. until the lactide is completely consumed, monitored by ¹H NMR spectroscopy. On completion of polymerization, 4 equivalents (with respect to the triflic acid) of Amberlyst A21 resin (4.6 meq/g), previously dried over P₂O₅, are added. The reaction medium is stirred for 45 minutes then filtered. Twice 2 equivalents of Amberlyst A21 resin are added to the reaction medium which is stirred for 45 minutes then filtered. The reaction solvent is then evaporated off under vacuum.

### Example 11

### Synthesis of a PLGA 80/20 Copolymer in Star Form

A PLGA copolymer in star form and with a lactide/glycolide ratio=80/20 is synthesized from trimethylolethane.

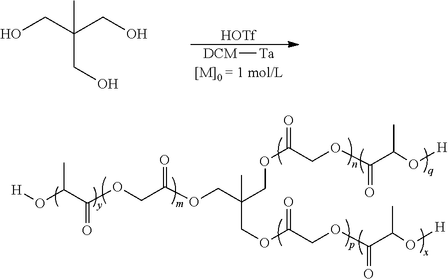

| | | | | | | DP_{NMR} | |
|---|---|---|---|---|---|---|---|
| | [M]₀/[I]₀/ | | Con- | | | per | n(CH₂—OPLA)/ |
| Ex | [HOTf]₀ | Time | version | M_{w} | Iₚ | arm | n(CH₂—OH)₀ |
| 11 | 9/1/0.3 | 5 | 95% | 1898 | 1.16 | 3 | 3/3 |
| | | hours | | | | | |

After stirring for 5 hours the glycolide is completely consumed and there is little residual lactide. The DP_{NMR} per arm is close to the theoretical DP (equal to 3) and ¹H NMR spectroscopy makes it possible to confirm that initiation has taken place on all the trimethylolethane alcohols.

Synthesis Protocol:

Lactide (7.8 equivalents), glycolide (1.2 equivalents) and polyol (1 equivalent) are suspended in freshly distilled dichloromethane ([LA]₀=1 mol·L⁻¹). Triflic acid (0.1 equivalent per OH) is then added and the reaction medium is vigorously stirred at T=26° C. until the lactide is completely consumed, monitored by ¹H NMR spectroscopy. On completion of polymerization, 4 equivalents (with respect to the triflic acid) of Amberlyst A21 resin (4.6 meq/g), previously dried over P₂O₅, are added. The reaction medium is stirred for 45 minutes then filtered. The operation is repeated once then the reaction solvent is evaporated off under vacuum.

¹H NMR (δ, CDCl₃, 300.1 MHz): 5.30-5.10 (11.4H, m, CH), 4.90-4.70 (7H, m, CH₂), 4.36 (3H, m, CH), 4.07 (6H, m, CH₂), 3.82 (3H, br s, OH), 1.60-1.48 (41.4H, m, CH), 1.01 (3H, m, CH) ppm.

DP_{NMR}=8.95

Lactide/glycolide ratio=80/20 (by ¹H NMR)

SEC (THF): M_{w}=1898, M_{w}/Mₙ=1.16

### Example 12

### Synthesis of a Star PLA in Toluene at 80° C.

In this example, toluene is used as solvent after distillation and the reaction mixture is heated to 80° C.

| | | | | | | DP_{NMR} | |
|---|---|---|---|---|---|---|---|
| | [M]₀/[I]₀/ | | Con- | | | per | n(CH₂—OPLA)/ |
| Ex | [HOTf]₀ | Time | version | M_{w} | Iₚ | arm | n(CH₂—OH)₀ |
| 12 | 9/1/0.3 | 30 | 97% | 2284 | 1.25 | 3 | 3/3 |
| | | min | | | | | |

Synthesis Protocol:

Lactide (LA) and prone initiator (polyol, 1 equivalent) are suspended in freshly distilled toluene ([LA]₀=1 mol·L⁻¹) and the reaction medium is heated to 80° C. under an argon atmosphere. Triflic acid (0.1 equivalent per OH) is then added and the reaction medium is vigorously stirred at T=26° C. for 30 minutes (complete consumption of the lactide, monitored by ¹H NMR spectroscopy). 4 equivalents (with respect to the triflic acid) of Amberlyst A21 resin (4.6 meq/g), previously dried over P₂O₅, are added. The reaction medium is stirred for 45 minutes at ambient temperature then filtered. The reaction solvent is then evaporated off under vacuum.

The analytical data of the polymer thus obtained are similar to those of Example 1.

### Example 13

### Synthesis of a Star PLA with 6 Branches

Dipentaerythritol is previously dried under vacuum in the presence of P₂O₅. Lactide is used in an enantiopure form (L) in dichloromethane ([LA]₀=1 mol/L), in the presence of 0.1 equivalent of triflic acid per alcohol. The polymerizations are carried out at ambient temperature. On completion of the reaction, the catalyst is neutralized by treatment with the basic resin Amberlyst A21.

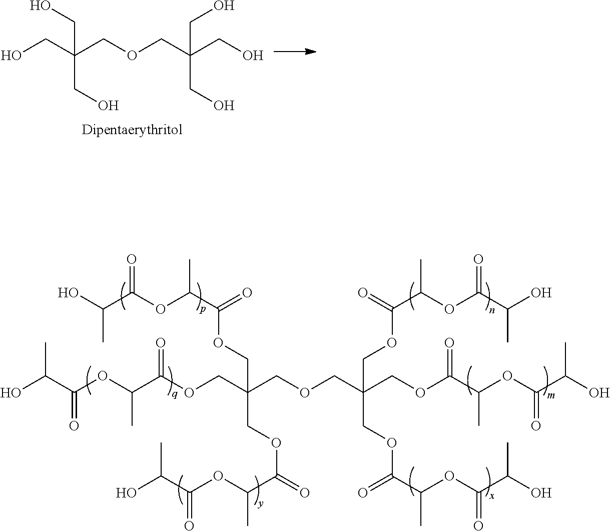

| | | | | | | DP_{NMR} | |
|---|---|---|---|---|---|---|---|
| | [M]₀/[I]₀/ | | Con- | | | per | n(CH₂—OPLA)/ |
| Ex | [HOTf]₀ | Time | version | M_{w} | Iₚ | arm | n(CH₂—OH)₀ |
| 13 | 18/1/0.6 | 8 h30 | 94% | 4320 | 1.20 | 3.1 | 3 / 3 |

Even in the case of a low monomer/initiator ratio, the polymer obtained is well controlled: the DP_{NMR} per arm is close to the theoretical DP (equal to 3) and, by means of ¹H NMR spectroscopy, the integration for 12H of the CH₂—O-PLAs coupled to the absence of signal at approximately 3.5 ppm (characteristic CH₂—OH region of the initiator) makes it possible to affirm that the initiation on all the dipentaerythritol alcohols is complete.

Synthesis Protocol:

Lactide (LA, 18 equivalents) and dipentaerythritol (1 equivalent) are suspended in freshly distilled dichloromethane ([LA]₀=1 mol·L⁻¹). Triflic acid (0.05 equivalent per OH) is then added and the reaction medium is vigorously stirred at T=26° C. until the lactide is completely consumed, monitored by ¹H NMR spectroscopy.

4 equivalents (with respect to the triflic acid) of Amberlyst A21 resin (4.6 meq/g), previously dried over P₂O₅, are added. The reaction medium is stirred for 45 minutes then filtered.

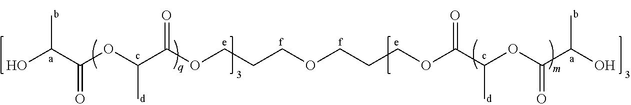

¹H NMR (δ, CDCl₃, 300.1 MHz): 5.22-5.07 (30H, m, CH_{c}), 4.35 (6H, q, CHₐ), 4.14 (12H, br s, CH₂ₑ), 3.35 (4H, br s, CH_{2f}), 1.61-1.47 (111H, m, CH₃) ppm.

¹³C NMR (δ, CDCl₃, 75.5 MHz): 175.1 (CO), 169.6 (CO), 69.9-67.7 (CHₚₒₗ+CH₂), 66.7 (CHOH), 62.8-62.7 (CH₂), 59.1 (CH₂OH), 20.5-20.3 (CH₃), 16.7-16.6 (CH₃ₚₒₗ) ppm.

DP_{NMR}=18

SEC (THF): M_{w}=4320, M_{w}/Mₙ=1.20

1. A method for preparing star polymers comprising polymerizing a lactide monomer, by ring opening in the presence of a:
a catalyst of formula 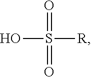
wherein R is a C₁ to C₆ haloalkyl;
an initiator, wherein the initiator is a polyol comprising from 3 to 6 hydroxyl functions.

2. The method according to claim 1, wherein the monomer is lactide.

3. The method according to claim 1, wherein the polymers are prepared based on a lactide monomer and a glycolide monomer.

4. The method according to claim 1, wherein the reaction takes place in an organic solvent.

5. The method according to claim 4, wherein the solvent is a halogenated solvent.

6. The method according to claim 1, wherein the initiator is a polyol comprising from 3 to 4 hydroxyl functions.

7. The method according to claim 6, wherein the initiator is glycerol.

8. The method according to claim 1, wherein the catalyst is trifluoromethanesulphonic acid.

9. The method according to claim 1, wherein said method is reacted at a temperature ranging from 0 to 150° C.

10. The method according to claim 1, wherein the method has a concentration ratio of initial monomer to OH functionality in the initiator from 200/1 to 1/1.

11. The method according to claim 10, wherein the concentration ratio is from 100/1 to 2/1.

12. The method according to claim 11, wherein the concentration ratio is from 20/1 to 4/1.

13. The method according to claim 1, wherein the method has a concentration ratio of initial catalyst to OH functionality in the initiator from 0.1 to 20.

14. The method according to claim 13, wherein the concentration ratio is from 0.2 to 10.

15. The method according to claim 14, wherein the concentration ratio is from 0.3 to 6.

16. The method according to claim 4, wherein the solvent is an aromatic solvent.

17. The method according to claim 5, wherein the halogenated solvent is dichloromethane.

18. The method according to claim 9, wherein the temperature ranges from 20 to 45° C.

19. The method according to claim 1, wherein the lactide monomer is polymerized in the presence of a glycolide.
